(19) United States
(12) Patent Application Publication
(10) Pub. No.: US 2005/0225592 A1
(43) Pub. Date: Oct. 13, 2005

(54) Inkjet cartridge cleaning devices

(75) Inventor: David R. Ginskey, Wichita, KS (US)

Correspondence Address: SHOOK, HARDY & BACON LLP, 2555 GRAND BLVD, KANSAS CITY,, MO, 64108, US

(73) Assignee: Stratitec Inc.

(21) Appl. No.: 10/821,033

(22) Filed: Apr. 7, 2004

(51) Int. Cl. B41J 2/165

(52) U.S. Cl. 347/30

(57) ABSTRACT

Disclosed are the devices and methods for cleaning the ports of a print head of a printer cartridge for refilling purposes. This is accomplished using two different kinds of tips which are alternatively disposed on the end of a syringe. A large tip is used to clean all of the ports simultaneously by applying suction to all. A smaller tip, however, is used to clean specific ports. The smaller tip is able to provide much greater suction than a larger tip because it has a minimized flow aperture. The larger tip, conversely, creates a very wide flow area which does not provide as great a suction, but provides other benefits.

### CROSS-REFERENCE TO RELATED APPLICATIONS

None.

### STATEMENT REGARDING FEDERALLY SPONSORED RESEARCH OR DEVELOPMENT

None.

### BACKGROUND OF THE INVENTION

1. Field of the Invention

The devices and methods of the present invention relate generally to the field of refilling inkjet cartridges. More specifically, the present invention relates to the technology of accessing suction to cartridge orifices. One aspect involves delivering suction to purge individual inkjet outlets. Another involves the delivery of suction to all of the outlets on the printhead. Different devices are used for both of these techniques. These two devices are syringe-mounted rubber tips. Each tip may be used in a variety of steps for purging the inkjet outlets.

2. Description of the Related Art

There are several commercially-available varieties of computer printers. Some use thermal heads. Others use lasers. Perhaps the most common sort of printer, however, uses ink jets.

These inkjet printers are very popular because they may be purchased at relatively low cost. Maintenance is not so cheap, however. The print head and ink container for an inkjet printer is typically included in a disposable unit. These disposable units may be very expensive. In some cases, such a cartridge may be good for printing less than 500 sheets of paper, and cost more than a fourth of the purchase price for the printer in which they are to be used. Considering this, the user may quickly incur maintenance costs which exceed the initial expense for the entire printer.

One reason for the high cost per cartridge is that a new print head is included with each unit. This print head has a useful life multiple times longer than the length of time provided by the ink included. Therefore, when a cartridge is discarded after running out of ink, a still-good cartridge and print head are wasted.

The problem is increased where color cartridges are concerned. Color cartridges typically have three separate color reservoirs. One for each of three primary colors. These colors will tend to run out at different rates. When the first of the three runs out, the user may throw out significant quantities of unused ink in the other two reservoirs.

The manufacturers of these cartridges have not provided the consumer with a way to replenish the ink within these cartridges, or even develop an alternative design in which does not require disposal of the cartridge. Instead, the manufacturers have created a cartridge that is difficult to refill.

Syringes have been used to deliver ink to cartridges in the prior art methods. With these arrangements, a typical syringe having a needle is used to draw ink out of a vial (typically) and deliver it to an access point on the cartridge. One example showing this are U.S. Pat. No. 5,515,663 issued to Allgeier, Sr., et al. Allgeier shows the use of a syringe to deliver ink to a cartridge. U.S. Pat. No. 5,199,470 issued to Goldman shows a similar arrangement, except using a needle on a squeeze bottle instead of a syringe. The Allgeier and Goldman techniques, however, have proved faulty. First, they cause leaks because the needles used do not create a sealed relationship with the particular orifice into which the ink is to be directed. Second, because the needle is long and sharp, it is difficult to control, and may pierce membranes, etc. in a manner that is undesirable. Further, these needles have shown to be ineffective for the purpose of filling numerous kinds of cartridges.

Another problem which dissuades some users from attempting refilling old cartridges is clogging. Most inkjet cartridges have a number of orifices at their bottom. These holes are very small, and comprise the ink outlets for the cartridge. The outlets will typically work in one of two ways.

The first type of inkjet technology, called bubble jet, uses thermal energy. In a bubble-jet arrangement, resistors are used to heat the ink and vaporize it. A vaporous bubble is thus created. As this bubble expands, some of the ink is pushed out of the outlets on the printhead at high velocity and accuracy onto the paper. The bubble then pops. This collapse creates a vacuum that serves to pull more ink into the printhead from the cartridge to be heated.

The second method of ink dispersal uses piezo crystals. These crystals are located behind the ink reservoir behind each outlet. A tiny charge is delivered to the crystals that causes them to vibrate. Inward vibrations of these crystals forces ink out through the outlets onto the paper.

Both the thermal and piezoelectric methods are very harsh ways to eject the ink from the outlet ports. Thus, the outlets may degrade, and oftentimes become clogged. Therefore, there is a need in the art for an effective method for removing clogs in these outlets during the refilling process.

### SUMMARY OF THE INVENTION

The method and devices of the present invention overcome the deficiencies present in the prior art methods of refilling ink cartridges. The present invention enables unclogging of the inkjet ports on the print head. This is accomplished using suction. The typical print head on an inkjet cartridge on a printhead has numerous ports disposed on it. These ports may all be for the same color of ink, or may be for different colors.

The present invention enables these ports to be effectively cleaned as part of the cartridge-refill process. This cleaning techniques, not possible with the prior art methods, use suction provided by a syringe. Two different types of syringe tips are used for two different sub-methods for suction cleaning. The first tip is useful in delivering greater suction strength to an individual port for cleaning. The second tip is used to clean all of the ports simultaneously, or to purge the printhead so that any air bubbles can be removed from the cartridge.

These two tips have distinct configurations.

The first tip comprises a sealing member having first and second ends. The member defines a conduit. This conduit has a first opening at the first end of the member. The first end of the member is fluidly connected to a pressure controller which provides the suction necessary. This pressure controller, in the preferred embodiment, is a syringe.

The conduit on this first tip also has a second opening at the second end of the sealing member. This second opening has a cross-sectional area which is less than that of the cross-sectional area of the first opening. The second opening is adapted to form a sealed fluid engagement with one and only one of the ejection ports on the print head. The conduit narrows cross-sectionally from the first end to the second end.

The first end of the sealing member of the first tip defines internal and external engaging surfaces. The internal engaging surface may be used for a syringe having a stem-type tip mount. The first end also has an external surface which may be used to receive the internal threads of a syringe having a luer lock tip arrangement.

The second tip of the present invention is adapted to fluidly communicate with and deliver suction to a plurality of injection ports at once. With this design, the cross-sectional area of the second opening of the member is larger than the cross-sectional area of the first opening. The conduit inside the member of this embodiment widens cross-sectionally from the first to the second ends of the member. It, like the fist embodiment, works with either the stem or luer-lock types of syringes in the same manner. Thus, it also has the internal and external engaging surfaces which enable it to be used with both stem and luer-lock types of syringes.

In use, the first tip of the present invention administers suction to one or a small group of ports on the print head. The second tip, conversely, administers suction to all the ejection ports simultaneously. The two tips, however, will be used in multiple ways. The order of use may be altered in any number of ways to accomplish different cleaning objectives.

The two types of tips are able to work together, one after the other, in any order, to deliver suction cleaning of inkjet outlets in ways not accomplishable conventionally. The first tip having the smaller orifice will provide a greater amount of suction to one single port. This is most useful when trying to clean difficult clogs or impurities in the print head. The second tip may be used to clean all the ports simultaneously. Though it will deliver less suction power than the smaller tip, it can be used to restore ink continuity to the print head. By this it is meant that air bubbles may form in the print head. Especially after use of the smaller tip attachment. Air bubbles are sometimes formed by the use of the smaller tip. This is because, when ink is sucked out of one port, air will likely be simultaneously sucked into the unengaged ports. This happens because both the engaged and unengaged ports are all included in the same fluid system within the cartridge. The larger tip may, therefore, be used to correct the air-bubble problems presented by the more powerfully cleaning smaller tip. Thus, the two tips are likely to be used together to provide a thoroughly clean print head which is free of air as intended.

### BRIEF DESCRIPTION OF THE SEVERAL VIEWS OF THE DRAWINGS

The present invention is described in detail below with reference to the attached drawing figures, wherein:

FIG. 1 is a perspective view of the sealing member of the present invention in use cleaning a cartridge print head. It shows the sealing member being used with a syringe having a stem-type tip receiver.

FIG. 2A shows the back of the first embodiment of the sealing member of the present invention.

FIG. 2B shows a cross-sectional view of the first embodiment of the sealing member of the present invention.

FIG. 2C shows a front view of the first embodiment of the sealing member of the present invention.

FIG. 3 shows a perspective view of the second embodiment of the sealing member in use on a cartridge. The syringe shown in the figure is of the stem-type.

FIG. 4A shows a back view of the second embodiment of the sealing member of the present invention.

FIG. 4B shows a cross-sectional view of the second embodiment of the sealing member of the present invention.

FIG. 4C shows a front view of the second embodiment of the sealing member of the present invention.

### DETAILED DESCRIPTION OF THE INVENTION

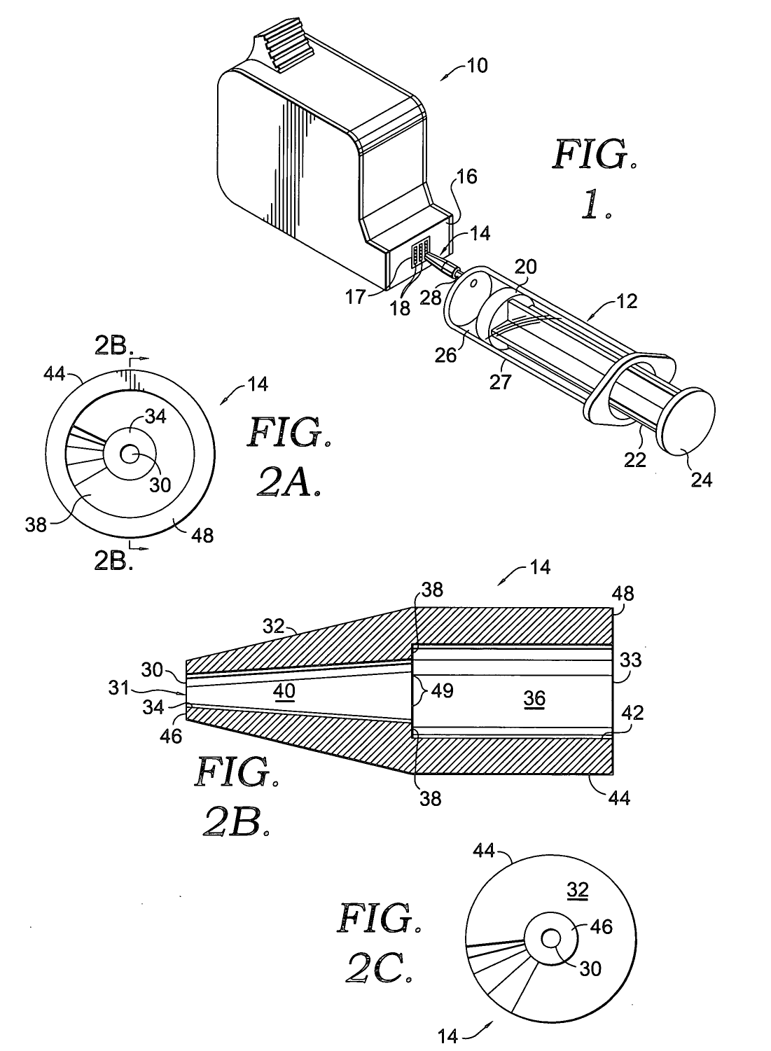

A first embodiment of the present invention is shown in FIGS. 1, 2A, 2B, and 2C. FIG. 1 shows how this system of the first embodiment is used. Referring to the figure, we see that cartridge 10 has a forward surface 16 on which the print head 17 is disposed. Print head 17 includes a plurality of ports 18. The ports on a particular cartridge like that of cartridge 10 will tend to become clogged the more cartridge 10 is used. The plurality of ports 18 comprises individual ports, each of which are micro holes through which ink is ejected by either thermal-bubble-jet or piezoelectric functional methods.

Both methods are hard on the plurality of ports 18. The typical cartridge 10 is not designed for continued use. Rather, it is designed to be discarded after one use and then thrown away. As noted above, refill kits have been used to get the most out of these types of cartridges. These types of kits enable cartridges like cartridge 10 to be refilled (and thus reused) two, three or even four times. With these multiple uses of the same cartridge, however, the ports will tend to clog and the print head becomes worn.

It has been discovered that refilled cartridges will perform much better if their print head is primed before returning the cartridge to service. The devices of the present invention do this by using suction.

The necessary suction, in the embodiments disclosed herein, is created using a syringe 12. Syringe 12, like most syringes, has a plunger 20, a drive shaft 22, and a head 24. Head 24 may be either pushed or pulled to either increase or decrease, respectively the pressure in a chamber 26. Chamber 26 is fluidly connected with a sealing member 14 through a conduit/passageway (not shown) defined through a delivery stem 28 (shown in FIG. 1). Syringes with the plunger 20, chamber 26, and stem 28 components like those of syringe 12 will be well known to those in the art, and are commercially available.

Member 14 is simply slid onto stem 28 for use.

In the preferred embodiment, member 14 is made of rubber. This is because rubber, as is often used in gaskets and other such devices, as been proven to be a durable and flexible material with great sealing properties. Other materials, however, could also be used which would fall within the scope of the present invention. For example, flexible plastics could also be used. Likewise, even rigid materials might be used and still fall within the scope of the present invention. However, for its attributes mentioned above, rubber has been chosen as the material for use in both embodiments disclosed herein.

FIGS. 2A, 2B, and 2C show more details regarding the sealing member 14 of the first embodiment of the invention. Member 14 has a forward end 31 and a rear end 33. At the forward end 31 of member 14 an aperture 31 is minimized. Its size is minimized so that it may deliver maximum suction force. Both an outside surface 32 and an inside surface 34 of the forward end 31 of member 14 are tapered, as can be seen in FIG. 2B. Surface 32 is tapered such that it can be easily inserted for filling purposes (as will be described hereinafter).

Inside tapered surface 34 is tapered such that the pressure created in conduit 40 is focused on a smaller cross-sectional area. In addition to maximizing the suction pressure administered to an individual port or small group of ports, through aperture 31, the taper also increases peripheral visibility of the printhead when targeting a particular port on the printhead for the application of suction.

At its rear end 33 member 14 includes a stem receiver 36 void. Stem receiver void 36 is a cylindrical channel which is disposed axially inside member 14. This is the component of member 14 which is used to receive the stem 28 of the typical syringe 12. When inserted, and then slid into stem receiver 36, the end of stem 28 which limits the stems progress into member 14 at a transitional plane consonant with a mouth 49 between the stem receiver void 36 and narrowing conduit 40. Narrowing conduit 40, because of its taper will have a reduced cross-sectional area towards forward end 31. Mouth 49 is formed at the inner most end of conduit 40. This mouth is coplanar with annular ridge 38.

Because the outside diameter of stem 28 is slightly greater than the inside diameter of the internal surface 42 in the stem receiver, stem 28 is elastically gripped and thus secured within the tip 14.

Tip 14 the first embodiment may also be used with other kinds of syringes. For example, another common sort of syringe which has been used is what is referred to as a luer-locking syringe. These syringes, which will be known to those skilled in the art, have stems with a larger outside diameter than those of the standard syringe (like that shown in FIG. 1). Instead, luer syringes are designed to engage the outside cylindrical surface of the needle or other attachment. Sometimes they engage using an internal set of threads on the inside cylindrical surface of the stem.

Member 14 has an outside surface 44 which is cylindrical. It is sized in a manner that it is received by the internal cylindrical stem of the luer lock syringe. Surface 44 fits within the luer stem. For a luer lock having internal threads, the threads engage surface 44. The engagement of the threads on surface 44 enable tip 14 to be screwed into the stem. For luers not having threads, tip 14 is simply pressed into the luer stem. In either case, the stem secures the tip 14 snugly therein and maintains good sealing properties.

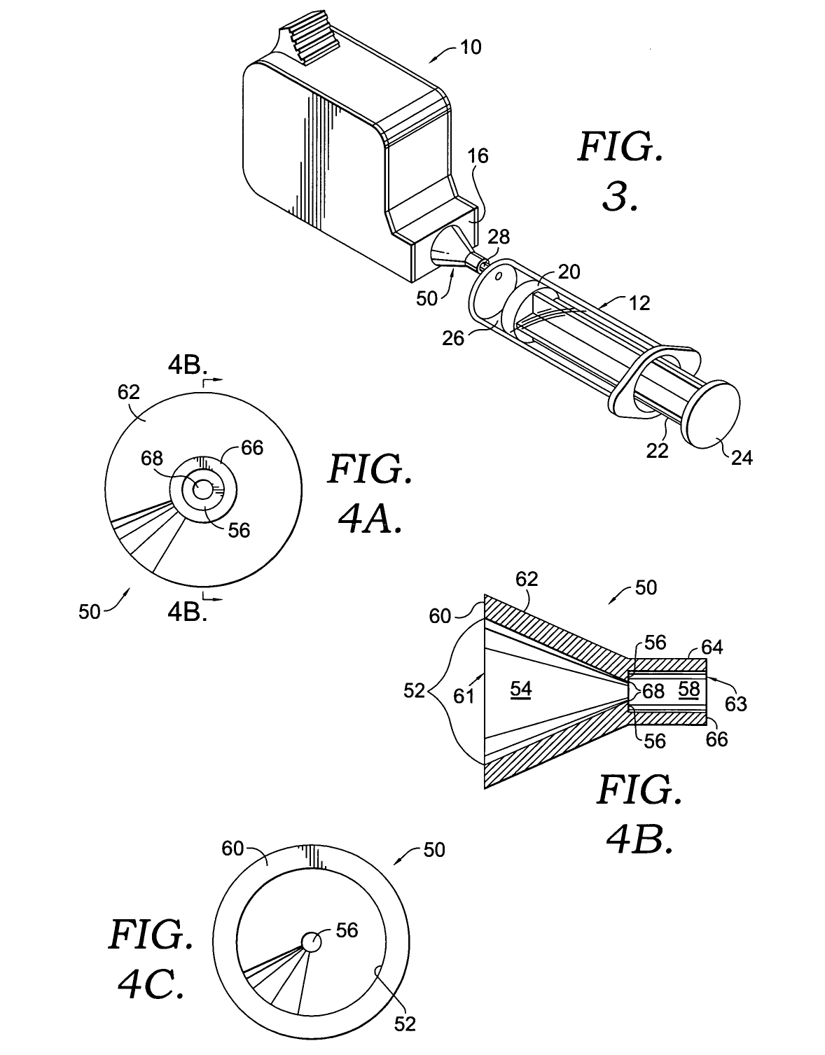

A second embodiment of the present invention is shown in FIGS. 3, and 4A through 4C. FIG. 3 shows a member 50 of the second embodiment in use on the same cartridge 10 and using the same syringe 12 as shown above in FIG. 1 (which illustrates the first embodiment).

Referring to FIG. 3, we see that member 50 of the second embodiment covers a much greater surface area of the forward surface 16 of the print head 18. In fact, the entire print head 17 is covered by the suction cup like member 50.

Referring to FIGS. 4A-C, we see the details regarding the specific configuration of member 50 of the second embodiment. As can be seen from these figures, it will be observed that a flow area 52 of second member 50 is much greater than that of the first member 14. This flow area has been maximized so that all of the plurality of ports 18 will be simultaneously subjected to suction. In order to do so, a wide flow area 52 is necessary. To create this widened flow area, a widening conduit 54 is defined axially inside member 50. Conduit 54 begins at a transition mouth 68 and extends to a forward end 61.

Like with the first embodiment, the member 50 of the second embodiment defines an annular ridge 56 which will engage the end of a standard syringe stem 28 when stem 28 is inserted into member 50. Stem 28 is received into a stem receiving void 58 defined in member 50, just like with the first embodiment.

Also like with the first embodiment, member 50 is comprised of flexible material, such as rubber. As explained above, many other materials could be used which would still fall within the scope of the present invention. However, rubber is being used here because of its superior properties in terms of flexibility, sealing, and gripping.

Stem 28 is held tightly engaged within stem receiver 58 because the outside diameter of stem 28 is slightly greater than the inside diameter of the cylindrical surface of receiver 58—just like with the first embodiment.

At the front end 61 of member 50 a print head engaging/sealing surface 60 is provided. Surface 60 will form a sealed perimeter about all of the ports 18 including them all. This subjects all of these ports simultaneously to suction when plunger 20 in pulled out of syringe 12 creating a vacuum in chamber 26.

Because the forward end 31 of member 50 is fanned outward, an outside widened surface 62 is created. Surface 62 expands radially beyond the center axis of member 50 and also beyond the extent of an outer surface 64 of member 50. Outer surface 64, like with the outer surface 32 of first embodiment as mentioned above, is capable of receiving the inside cylindrical surface of a luer-lock syringe stem.

Thus the details regarding the two different embodiments, member 14, and member 50 have been described. We will now discuss the manner in which these devices are used to accomplish the methods of the present invention.

Once a used cartridge has been selected for refilling, that cartridge should be filled with ink in a manner known to those skilled in the art. Once this cartridge has been filled up with new ink, the priming should begin. Priming is just another word for cleaning out of the ports 18 of print head 17.

This process will likely begin by attaching the small suction tip 14 to a clean syringe. Alternatively, the large tip 50 could be started with, if desired. Large tip 50 has been selected here, though, because it is a useful as a preliminary tool. It may be used, first off, in identifying which ports in the printhead are clogged. To do this, the print head should be wipe clean of any ink existing thereon. Next, front end 61 of the large tip 50 should be pressed against surface 16 of the cartridge so that it completely covers the printhead 17 (or at least covers all of the ports in the plurality 18). After this, the plunger 20 of syringe 12 should be drawn out by retracting driver 22 using head 24. This creates a vacuum in chamber 26 which draws ink out through the outlets 18.

Plunger 20 should only be drawn out a little bit. This will minimize the amount of cleaning accomplished, but will work well for the purpose of identifying clogged ports. This is because, in order for the clogged ports to be identified, only a small amount of ink should be drawn out of the clear ports. Otherwise, ink would spill out all over the printhead to cover all the ports. Even the clogged ones. Thus, it would be difficult to identify the emitting-clear versus non-emitting-occluded ports.

The user should then remove the syringe 12 and tip 50 from the cartridge and observe the printhead. The clean ports will be observed having ink on our about them whereas the dirty, plugged ports will be dry of ink.

Once the dirty, plugged ports have been identified, they should be suctioned using the smaller, more powerful tip 14. Tip 14's forward end 31 should be pressed against the printhead 17 so that the printhead-engaging sealing surface 46 completely surrounds the dirty port to be cleaned, and forms an airtight seal around it.

Suction should then be applied to the selected port by pulling plunger 20 out of the syringe 12 until a small amount of ink appears in the syringe. Thus, the dirty port should have been adequately cleaned.

It is preferable that as little ink as possible be drawn out to avoid hydrostatically sucking air into the cartridges internal systems through the other ports (the ones not presently being cleaned by tip 14). Some air intake is inevitable. This is because all the ports are included in the same fluid system in the cartridge (for a single-reservoir-type cartridge). Thus, when strong suction is delivered to a single port, air is hydrostatically drawn into the other ports. This problem, however, is solvable using large suction tip 50 in a manner which will be discussed below.

This same process (individual suctioning with tip 14) should be repeated for each of the individual dirty ports observed during the identification step referred to above. Either after all of the ports have been cleaned with tip 14, or sometimes in between individual port cleanings, large tip 50 should be used to purge the entire printhead of air. This is done by pressing forward end 61 of member 50 against the print head 17 to suction all of the ports 18 just like in the identifying step, except that here, the plunger should be withdrawn until a small amount of ink is visible in the syringe. Air bubbles trapped in the printhead and cartridge can be very problematic when the inkjet cartridge is returned to service. The reasons for this will be evident to those skilled in the art. Thus, air purging with large tip 50 is usually the norm in order to avoid these air-intrusion-dilemmas.

Once the cartridge has been purged of air, the syringe and member 50 should be removed, and the ports reexamined to determine if ink is coming out of the ports which were clogged. It should then be visible to the user that ink is coming out of some, if not all the ports. If some ports remain clogged, however, these still-clogged ports should be cleaned by repeating the above processes.

Though a specific process has been described above, it will be recognized to one skilled in the art that the potential uses for tips 14 and 50 go well beyond those disclosed above. These tools are very versatile, and the user will be able to pick and choose how they can be used together or separately to accomplish many different objectives.

Normally, it will be advantageous to begin with the larger tip 50 for identification, individually clean with tip 14, and then purge with tip 50. But the use of each of tips 14 and 50 either alone, or in different orders of application have been shown to be effective in many situations. Therefore, any particular order of application or combination should necessarily be considered limiting unless specified in the claims below.

It is also possible to use tips 14 and 50 for filling purposes. When a cartridge is refilled, syringes have been used in the past. See Background Section. These techniques, however, usually involve the use of a needle. Needles are a very intrusive means for injecting ink into a cartridge.

In refilling a cartridge, a syringe-mounted needle is inserted into an orifice in the cartridge to inject the ink. The needle does not create a sealed arrangement. Thus, ink spillage is likely. Also, many of these orifices are associated with a membrane which may be ruptured by the needle.

The tips of the present invention, however may be inserted into (for smaller tip 14) or displaced around (for large tip 50) the orifice (or orifices) in the cartridge to inject the ink. Either tip will create a sealed relationship which does not allow for spillage. The tips are also not intrusive at all, thus, will not rupture membranes or other delicate cartridge structures.

Thus, there have been shown and described devices and methods for removing clogs, and otherwise cleaning the ports in a print head of an inkjet cartridge for refilling purposes which fulfills all of the objects and advantages sought therefore. Many changes, modifications, variations, and other uses and applications of the subject invention will, however, become apparent to those skilled in the art after considering this specification together with the accompanying figures and claims.

1. A system for cleaning a print head of an inkjet cartridge of a printer, said print head having a total number of ejection ports thereon, comprising:
a sealing member having first and second ends;
a conduit defined by said member;
a first opening of said conduit at said first end of said sealing member, said first opening having a cross-sectional area, said first end of said member being fluidly connected to a pressure controller, said pressure controller used to control the pressure in said conduit; and
a second opening of said conduit at said second end of said sealing member, said second opening having a second cross-sectional area, said second opening of said conduit being adapted to form sealed fluid communications with one of said number of ejection ports.

2. The system of claim 1 wherein the cross-sectional area of said second opening is smaller than the cross-sectional area of said first opening.

3. The system of claim 2 wherein said conduit narrows cross-sectionally from said first end to said second end.

4. The system of claim 2 wherein said second opening is defined in a printhead engaging sealing surface, said sealing surface creating said sealed fluid communication with one of said number of ejection ports.

5. The system of claim 1 wherein said pressure controller comprises a syringe, said syringe having a housing which slideably receives a plunger which when activated decreases or increases the pressure in a chamber defined by said plunger and said housing, said chamber opening through a sealing-member receiver, said receiver adapted to sealingly receive said sealing member and enable fluid communications between said chamber and said conduit in said sealing member.

6. The system of claim 5 wherein said receiver is a stem protruding from said syringe housing.

7. The system of claim 6 wherein said first end of said member defines a stem engaging internal surface for engagedly receiving and holding said stem of said syringe. having a stem conduit narrows cross-sectionally from said second to first ends.

8. The system of claim 5 wherein said syringe has an external engagement configuration comprising internal threads.

9. The system of claim 8 wherein said first end of said member includes an outer surface adapted to receive said internal threads of said syringe external engagement arrangement forming a seal therebetween.

10. The system of claim 1 wherein the second opening is adapted to fluidly communicate with a plurality of said ejection ports at once.

11. The system of claim 10 wherein the cross-sectional area of said second opening is larger than the cross-sectional area of said first opening.

12. The system of claim 11 wherein said conduit widens cross-sectionally from said first end to said second end.

13. The system of claim 10 wherein said second opening is defined in a printhead engaging sealing surface, said sealing surface creating said sealed fluid communication with one of said plurality of said ejection ports.

14. The system of claim 10 wherein said pressure controller comprises a syringe, said syringe having. a housing which slideably receives a plunger which when moved decreases or increases the pressure in a chamber defined by said plunger and said housing, said chamber opening through a sealing-member receiver, said receiver adapted to sealingly receive said sealing member and enable fluid communications between said chamber and said conduit in said sealing member.

15. The system of claim 14 wherein said receiver is a stem protruding from said syringe housing.

16. The system of claim 15 wherein said first end of said member defines a stem engaging internal surface for engagedly receiving and holding said stem of said syringe.

17. The system of claim 14 wherein said syringe has an external engagement configuration comprising internal threads.

18. The system of claim 17 wherein said first end of said member includes an outer surface adapted to receive said internal threads of said syringe external engagement arrangement forming a seal therebetween.

19. The system of claim 10 wherein the second opening is adapted to fluidly communicate with substantially all of the plurality of ejection ports at once.

20. A method for cleaning a print head of an inkjet cartridge of a printer, said print head having a plurality of ejection ports thereon, comprising:
administering suction to one of said ports to clean said at least one of said ports.

21. The method of claim 20, comprising:
simultaneously administering suction to all of said plurality of said ejection ports to clean said plurality.

22. A method for cleaning a print head of an inkjet cartridge of a printer, said print head having a plurality of ejection ports thereon, comprising:
simultaneously administering suction to all of said plurality of said ejection ports to clean said plurality.
